(19) United States
(12) Patent Application Publication
(10) Pub. No.: US 2014/0077611 A1
(43) Pub. Date: Mar. 20, 2014

(54) CAPACITOR BANK, LAMINATED BUS, AND POWER SUPPLY APPARATUS

(71) Applicants: Henry Todd Young, Erie, PA (US); Alvaro Jorge Mari Curbelo, Bavaria (DE); Jason Daniel Kuttenkuler, Lawrence Park, PA (US); Sean Cillessen, Lawerence Park, PA (US)

(72) Inventors: Henry Todd Young, Erie, PA (US); Alvaro Jorge Mari Curbelo, Bavaria (DE); Jason Daniel Kuttenkuler, Lawrence Park, PA (US); Sean Cillessen, Lawerence Park, PA (US)

(21) Appl. No.: 13/617,768

(22) Filed: Sep. 14, 2012

(51) Int. Cl. H01G 2/00; H02J 1/00

(52) U.S. Cl. CPC H01G 2/00; H02J 1/00
USPC 307/82; 307/109; 174/68.2

(57) ABSTRACT

A capacitor bank includes a laminated bus bar having a high potential conductive layer and a low potential conductive layer disposed in close proximity at opposing surfaces of an intervening insulation layer. The bank also includes a plurality of bus capacitors electrically connected to the laminated bus bar. The laminated bus bar and the bus capacitors having a combined inductance sufficiently low such that the bus capacitors are electrically connected effectively in parallel with the laminated bus bar.

### BACKGROUND

1. Technical Field

Embodiments of the invention relate generally to power supplies. Particular embodiments relate to solid state switched power supplies.

2. Discussion of Art

Power supplies are electronic/electrical circuits that supply electric power to one or more electric loads. The term “power supply” is most commonly applied to collections or an assembly of electrical devices that convert one form of electrical energy to another and are commonly referred to as “power converters.” Many power supplies include two or more power converters connected together. Typically, power converters are “switching” power converters, in which multiple solid state devices are to used to intermittently interrupt an input current so as to effectuate conversion of the input current to an output current having different amplitude, voltage, and/or frequency. For example, an “AC power converter” receives direct or alternating input current and produces alternating output power at design values of voltage, current, and/or frequency. By contrast, a “DC power converter” produces output power at a substantially constant output voltage and/or current.

Conventional power converters, generally, are groupings of plural solid state switches that are connected to AC output terminals from a high potential DC rail or from a lower potential DC rail. The two DC rails typically are known jointly as a “DC link,” while the term “DC link voltage” often is used to refer to a potential difference across this DC link. Typically, the solid state switches are transistors that are switched to generate alternating current from the DC source rails. Switching of the transistors induces voltage surges between the DC rails and the AC output terminals. Accordingly, each transistor is packaged together with an anti-parallel diode for surge mitigation. Additionally, capacitors are sometimes connected across the power terminals of single switches, in order to mitigate fast voltage and current slopes during the switching transients. In particular, “snubber” capacitors have this purpose. Moreover, each voltage source power converter requires one or more capacitors connected directly or in very close proximity across the DC link terminals of that power converter to further mitigate inductive voltage surges across the converter switches. “Commutating” capacitors have this purpose.

Capacitors conduct a leakage current during voltage transients, have measurable resistance, and therefore dissipate heat each time they absorb a voltage surge. Each capacitor is deliberately specified with a safety margin such that electrical design parameters, e.g., dielectric breakdown, should not be approached during normal operation. Also, each capacitor is specified to withstand design temperature transients. As will be appreciated, these features add costs in design, manufacturing, and operation. For example, the capacitors require additional design work. They also require additional parts purchase, tracking, and assembly.

In operation, the capacitors cause each conventional power converter to occupy greater volume, and to dissipate more heat, than would otherwise be needed, thereby diminishing the attainable gross power density. Heat dissipation from the capacitors also increases a parasitic load required for cooling the power converters, thereby reducing the attainable net power density as installed. Moreover, each capacitor serves only a partial duty cycle during normal operation of a power converter. As such, the conventional power converters that include the capacitors have significant excess cost, have higher cooling requirements, and have lower gravimetric and volumetric net power density than would be desirable.

In view of the above, it is desirable to reduce the cost and cooling requirements of power supplies, while enhancing their power density. Therefore, it is desirable to provide power supplies capable of safe operation with smaller capacitors.

### BRIEF DESCRIPTION

In embodiments, a capacitor bank includes a laminated bus bar having a high potential conductive layer and a low potential conductive layer disposed at opposing surfaces of an intervening insulation layer. The bank also includes a plurality of bus capacitors electrically connected to the laminated bus bar. The laminated bus bar and the bus capacitors have a combined inductance sufficiently low such that the bus capacitors are electrically connected effectively in parallel with the laminated bus bar.

In other embodiments, a power supply apparatus includes a laminated bus bar having a high potential conductive layer and a low potential conductive layer disposed in close proximity at opposing surfaces of an intervening insulation layer. The high potential conductive layer includes an array of high potential vias and the low potential conductive layer includes an array of low potential vias. The apparatus further includes plural bus capacitors each having a high potential terminal electrically connected to the high potential conductive layer and having a low potential terminal electrically connected to the low potential conductive layer of the bus bar, and plural power converters, each connected across one of the high potential vias and one of the low potential vias. The power converters have no commutating capacitors.

In other embodiments a laminated bus bar has an insulation layer that extends along an axis and defines a substantially uniform profile orthogonal to the axis. The profile includes a first wing and a second wing protruding at an angle from a longitudinal edge of the first wing. The bus bar also includes a first conductive layer disposed at a first surface of the insulation layer, and a second conductive layer disposed at a second surface of the insulation layer opposite the first conductive layer. First and second pluralities of vias are formed in electrical contact with the first conductive layer, through the first wing and through the second wing, respectively. Third and fourth pluralities of vias are formed in electrical contact with the second conductive layer, through the first wing and through the second wing, respectively.

### DRAWINGS

The present invention will be better understood from reading the following description of non-limiting embodiments, with reference to the attached drawings, wherein below:

FIG. 1 illustrates, in electronic schematic view, a modular snubberless power supply according to an embodiment of the present invention.

FIG. 2 illustrates, in schematic sectional view, the modular snubberless power supply shown in FIG. 1.

FIG. 3 illustrates, in perspective view, the modular snubberless power supply shown in FIG. 1.

FIG. 4 illustrates, in schematic view, a data parallel signal flow among master and slave power converters, according to one aspect of the present invention.

FIG. 5 illustrates, in schematic view, a data serial signal flow among master and slave power converters, according to another aspect of the present invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description. Although exemplary embodiments of the present invention are described with respect to an AC power supply, embodiments of the invention also are applicable for use with power supplies, generally.

Aspects of the invention relate to modular power converters that are built without capacitors. Further aspects of the invention relate to power supplies built onto a laminated bus bar, such that the relatively low inductance of the bus bar permits effective parallel connection of numerous bus capacitors in a bank for absorbing voltage surges. Further aspects of the invention relate to such power supplies, in which the combined inductance of bus bars and bus capacitors is sufficiently small to enable modular connection of “snubberless” power converters that do not include capacitors. Further aspects of the invention relate to power supplies built with reduced mass and volume relative to conventional power supplies, in which snubberless power converters are spaced more closely than is feasible in a conventional power supply, thereby enabling greater gross power density as manufactured. Further aspects of the invention relate to power supplies built with reduced cooling requirements relative to conventional power supplies, in which snubberless power converters dissipate less heat than in a conventional power supply, whereby the reduced cooling requirements allow building the power supplies with fewer or lower-rated cooling components, enabling greater net power density as installed. Further aspects of the invention relate to power supplies built on a modular bus bar architecture, on which bus capacitors and snubberless power converters can be added or removed in modular (“plug and play”) fashion.

As used herein, the terms “substantially,” “generally,” and “about” indicate conditions within reasonably achievable manufacturing and assembly tolerances, relative to ideal desired conditions suitable for achieving the functional purpose of a component or assembly.

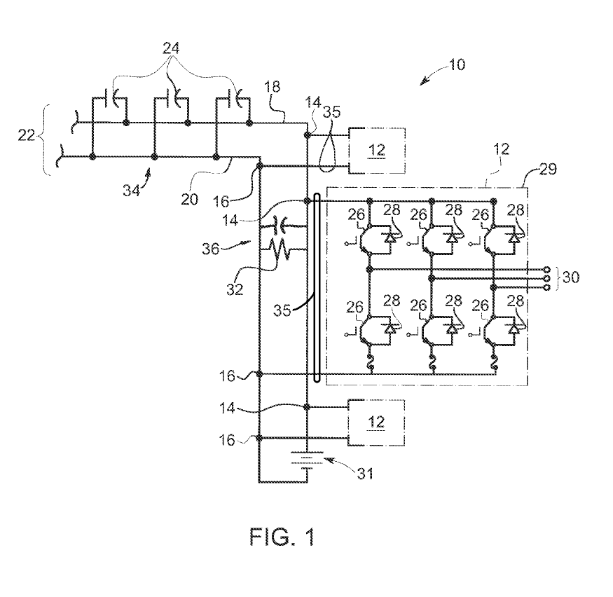

In an exemplary embodiment, as shown in FIG. 1, a modular power supply 10 includes plural snubberless power converters 12 that are connected at vias 14, 16 to high and low potential layers 18, 20 of a laminated DC bus bar 22, in parallel with bus capacitors 24. For example, the vias 14, 16 are configured as bushings for receiving threaded fasteners, such as cap screws (not shown) for electrically connecting terminals of the power converters 12 with the bus bar layers 18, 20. Each power converter 12 includes a plurality of power transistors 26 (e.g., IGBTs, MOSFETs, JFETs, BJTs, or other solid state switchable devices), each connected with an anti-parallel diode 28 between one of the layers 18 or 20 and one of several AC output terminals 30. (By “anti-parallel” it is meant the diode cathode is connected to the transistor collector, while the diode anode is connected to the transistor emitter.) The power transistors 26 and the anti-parallel diodes 28 are packaged within a power converter housing 29. The layers 18, 20 of the DC bus bar 22 also may be connected with positive and negative poles of a DC current source 31, which may include a generator, a photovoltaic cell, a thermovoltaic pile, an energy storage device (e.g., a battery or a flywheel), and/or other source of direct current.

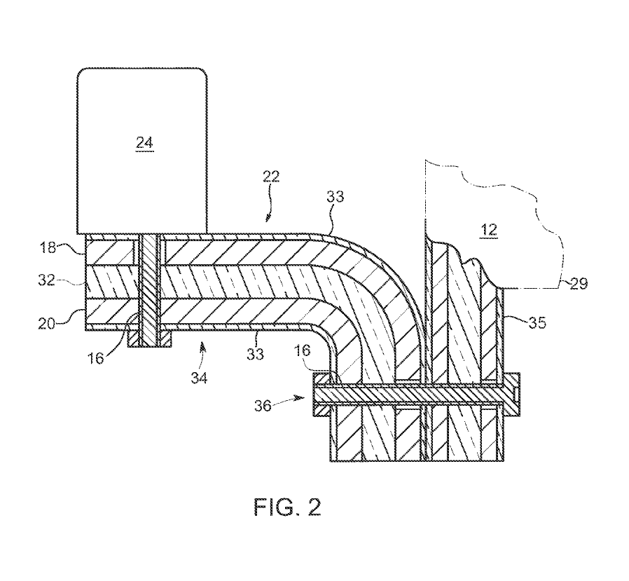

Referring to FIG. 2, the laminated DC bus bar 22 includes the high potential layer 18 and the low potential layer 20, which are sandwiched around (separated by) an insulation layer 32. (“High potential” and “low potential” are relative to one another, meaning that in operation with a DC source 31 connected to the layers 18, 20, a high potential element (e.g., layer 18) is at a higher potential than a low potential element (e.g., layer 20), which is at a lower potential then the high potential element.) The high potential and low potential layers 18, 20 are relatively thin layers having relatively high conductance (e.g., less than 3 mm thick; less than 2E-8 ohm-m resistivity). These layers are disposed in close proximity at opposing surfaces of the insulation layer 32, which is a relatively thin layer having relatively high dielectric strength (e.g., less than 2 mm thick; more than 30 kV/m). For example, the insulation layer 32 can be composed of PET, Teflon, melamine resin, or similar highly resistive polymers. The high potential and low potential layers can be composed of copper, aluminum, or similar highly conductive metals. Because the conductive layers are thin, relatively close together, and conduct current in generally opposite directions at any point across the bus bar 22, the magnetic energy stored by the laminated bus bar 22 approaches zero in direct current applications, even during switching of current. Thus, the laminated DC bus bar 22 presents low inductance to the power converters 12. Additional thin insulating layers 33, similar to the insulation layer 32, are provided at outer surfaces of the conductive layers 18, 20. Each individual power converter 12 includes a similarly laminated power supply bar 35, which protrudes from the power converter housing 29 for attachment to the laminated bus bar 22 at the vias 14, 16.

Referring back to FIG. 1, one aspect of the invention is that the relatively low inductance of the laminated bus bar 22 makes it possible to mount numerous bus capacitors 24, separate from any of the plural snubberless power converters 12, and without significant self-induction of the bus bar 22 during current transients between the bus capacitors 24 and the several power converters 12. In contrast, the inductance of conventional “rail” style bus bars serves to effectively isolate each bus capacitor from its neighbors and from power converters to which that bus capacitor does not have a direct mechanical connection. Thus, in embodiments of the invention, the bus capacitors 24 can be effectively connected in parallel and can be load shared among the power converters 12 to achieve desirably high working capacitance with a relatively low net inductance. In one aspect, “effectively connected in parallel” or “connected effectively in parallel” mean that a combined inductance of the bus bar 22 and of the bus capacitors 24 is sufficiently small such that all of the bus capacitors 24 can substantially equally absorb an inductive surge across any pair of high and low vias 14, 16. For example:

$${L}_{s} \leq k {t}_{sw} \frac{{U}_{d c}}{{I}_{p h}}$$

where Ls=combined inductance of the bus bar 22 and of the bus capacitors 24; Udc=DC link operating voltage; k=(transistor 26 blocking voltage−Udc)/Udc; tsw=time each of switches 26 takes to switch the current; and Iph=phase current to be switched. For example, where Udc=800 V, transistor blocking voltage=1200 V, tsw=0.1 μs, and Iph=1200 A, then Ls should not exceed about 33 nH if the capacitors 24 are to be effectively connected in parallel with the plural power converters 12.

As an advantage of the present invention, fewer bus capacitors can be used to accomplish the same commutation previously provided by numerous capacitors within individual power converters.

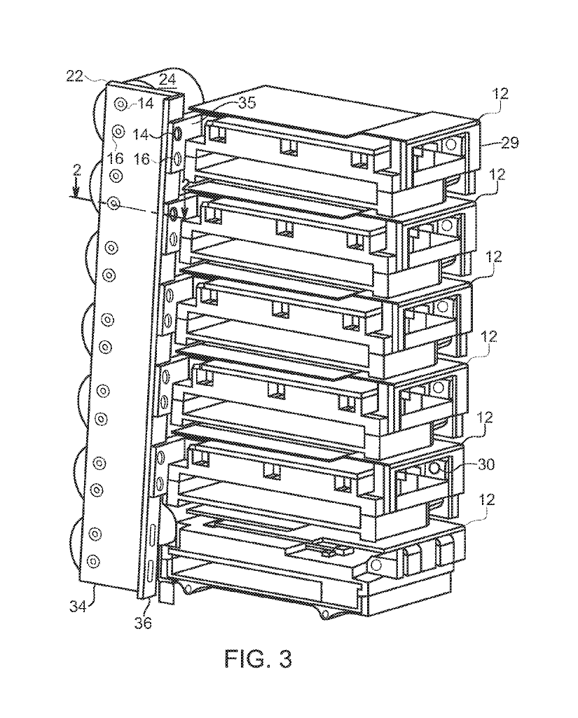

For example, as shown in FIGS. 2 and 3, plural bus capacitors 24 are connected in parallel at a first wing 34 of the laminated bus bar 22, while plural power converters 12 are connected in parallel by their power supply bars 35 at a second wing 36. The bus capacitors 24 and the bus bar 22 together provide an effective low commutation inductance for all legs of all power supplies as seen at the vias 14, 16 for each of the power converters 12. The bus capacitors 24, together with the laminated bus bar 22, provide enough capacitance to enable stable operation of each of the power converters 12. By way of example, five power units each rated for 60 kW would see a relatively low value of bus inductance (e.g., less than about 50 nH), and given the relatively high bus capacitance shared by the power converters 12 (e.g., about 10 mF), it is possible to cycle the power transistors 26 at up to about a few kHz without incurring voltage surges exceeding the individual switches blocking capability. Thus, it is possible to provide a power supply assembly 10 including power converters 12 that do not have capacitors internal to the power supplies. Moreover, capacitance installed according to embodiments of the present invention is spatially disjoint from each power converter housing. Whereas conventional designs require the installation within each power converter housing 29 of a capacitance in the order

$$20 \frac{P ( kVA )}{{U}_{d c}^{2}}$$

[here P is the converter rated power in kVA, Udc the DC link voltage in V and the result is in F], select embodiments of the present invention may require a total ancillary capacitance, inside each converter housing 29, of no more than 1/100^{th} that value.

An absence of capacitors diminishes the total volume required for each of the modular power converters 12, and also diminishes the cooling airflow required by each of the modular power converters 12, which means that it is possible to mount each power converter 12 closely adjacent to a next power converter 12. For example, in an embodiment, each power converter has a power rating of at least about 55 kW and occupies a volume of about 500 mm×290 mm×140 mm, for power density of about 2.7 W/cm³. The power converters 12 are arrayed along the laminated bus bar 22 at a spacing of about 145 mm on centers.

Indeed, the cooling air flows around the bus capacitors 24. Because the low inductance of the laminated bus bar 22 permits each of the bus capacitors 24 to be mounted without direct mechanical connection to any particular one of the power converters 12, the bus capacitors can be arranged for maximal heat transfer. For example, the bus capacitors 24 are shown protruding from the first wing 34 of the bus bar 22, such that cooling air can flow vertically around and among the bus capacitors for advantageous convective heat transfer.

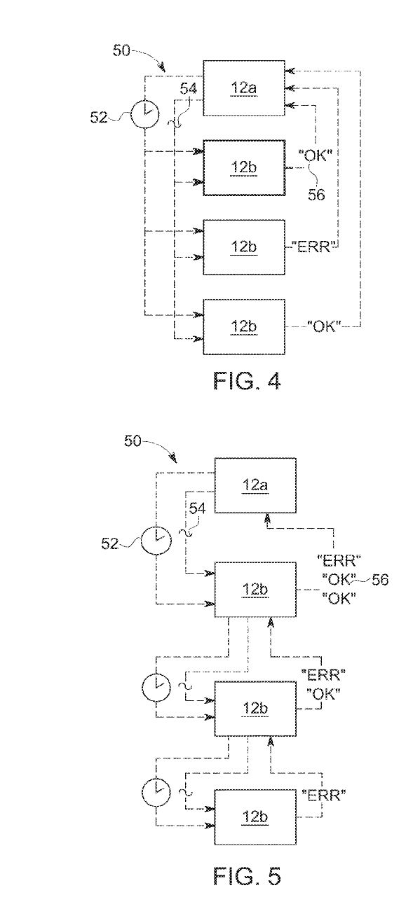

Referring to FIG. 4, another aspect of the invention is shown with reference to signal flows 50 between plural power converters 12 within the exemplary inventive power supply 10. Here, a first power converter 12a is shown as the “master” converter. As used herein, “master” means a single power converter configured to set timing and otherwise direct operation of additional “slaved” power converters connected to the laminated DC bus bar 22. For example, the master power converter 12a sends at least a timing signal 52, as well as a frequency select signal 54, to plural power converters 12b, 12c, etc., which are shown as “slaved” power converters. Each of the slaved power converters, in turn, sends a status-and-errors signal 56 to the master power converter 12a.

In FIG. 4 the slaved power converters are shown connected in data parallel, in other words, each directly communicating with the master power converter. On the other hand, FIG. 5 shows slaved power converters connected in data series, in other words, each one linking to the next toward the master power converter.

Thus, in embodiments, a capacitor bank (for a power supply apparatus) includes a laminated bus bar and a plurality of bus capacitors. The bus bar has a high potential conductive layer and a low potential conductive layer that are disposed at opposing surfaces of an intervening insulation layer. The capacitor bank further includes a plurality of bus capacitors electrically connected to the laminated bus bar. The laminated bus bar and the bus capacitors have a combined inductance sufficiently low such that the bus capacitors are electrically connected effectively in parallel with the laminated bus bar.

In embodiments, the high potential conductive layer includes an array of high potential vias and the low potential conductive layer includes an array of low potential vias. Each capacitor has a high potential terminal connected at the high potential conductive layer of the laminated bus bar and has a low potential terminal connected at the low potential conductive layer of the laminated bus bar. The laminated bus bar and the bus capacitors present minimal combined or parasitic inductance, which is sufficiently low such that the bus capacitors are electrically connected effectively in parallel with the high potential vias and the low potential vias. For example, the combined parasitic inductance is minimally small such that all of the bus capacitors can substantially equally absorb an inductive surge across any pair of the high and low potential vias. In certain embodiments, at least one power converter is electrically connected to the bus bar across at least one high potential via and at least one low potential via, effectively in parallel with the bus capacitors, such that the power converter can operate without needing to house a commutating capacitor. In such embodiments, the at least one power converter may be a first power converter of a plurality of power converters, all electrically connected effectively in parallel with the bus capacitors and having no internal commutating capacitors. Embodiments may further include at least one DC current source electrically connected to the bus bar effectively in parallel with the power converters. The DC current source may include any one or more of a battery, an ultra-capacitor, a photovoltaic cell or array, or a DC generator. In embodiments, the first power converter may be configured as a master power converter, with the additional power converters connected in data parallel to the master power converter. Or the first power converter may be configured as a master power converter, with the additional power converters connected in data series to the master power converter. In embodiments, the bus capacitors are connected at a first wing of the laminated bus bar, while the high potential vias and the low potential vias are formed at a second wing of the laminated bus bar that extends generally orthogonal to the first wing. Thus it is possible for the plural power converters to be spaced together more closely than would be possible for power converters having commutating capacitors.

In embodiments, a power supply apparatus includes a laminated bus bar, bus capacitors, and power converters. The laminated bus bar has a high potential conductive layer and a low potential conductive layer disposed in close proximity at opposing surfaces of an intervening insulation layer. The high potential conductive layer includes an array of high potential vias. The low potential conductive layer includes an array of low potential vias. Each bus capacitor has a high potential terminal electrically connected to the high potential conductive layer and has a low potential terminal electrically connected to the low potential conductive layer of the bus bar. Each power converter is connected across one of the high potential vias and one of the low potential vias. Different to state of the art, the power converter housings enclose no commutating capacitors but house only ancillary capacitance, as for mitigating ground loops or the like. Accordingly, in some embodiments, the power converters are spaced more closely together than could be achieved for power converters having commutating capacitors. For example, power converters may be provided with net power densities of at least about 2.6 W/cm³ and spacing of no more than about 15 cm on centers. In embodiments, the power converters may include at least one power converter configured for supplying current to the laminated bus bar and at least one other power converter configured for receiving current from the laminated bus bar.

In embodiments, a laminated bus bar includes an insulation layer extending along an axis and defining a profile orthogonal to the axis. The profile includes a first wing and a second wing protruding at an angle from a longitudinal edge of the first wing. The laminated bus bar also includes a first conductive layer disposed at a first surface of the insulation layer, and a second conductive layer disposed at a surface of the insulation layer opposite the first conductive layer. First and second pluralities of vias are formed, in electrical contact with the first conductive layer, through the first wing and through the second wing, respectively. Third and fourth pluralities of vias are formed, in electrical contact with the second conductive layer, through the first wing and through the second wing, respectively. In certain embodiments, the first and second conductive layers are in close proximity, such that the article presents minimal parasitic inductance across the pluralities of vias. In certain embodiments, the first and second pluralities of vias are arrayed along the axis of the article. In such embodiments, the third and fourth pluralities of vias may be arrayed along the axis at locations respectively corresponding to the first and second pluralities of vias. In certain embodiments, the profile of the laminated bus bar may be substantially uniform along the axis. Some embodiments may extend to a power supply apparatus, which includes the laminated bus bar along with plural bus capacitors attached at the first wing and electrically connected across the first conductive layer and the second conductor layer by way of the first and third pluralities of vias, as well as plural power converters attached at the second wing and electrically connected across the first conductive layer and the second conductor layer by way of the second and fourth pluralities of vias.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of the elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described power supply apparatus, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A capacitor bank comprising:
a laminated bus bar having a high potential conductive layer and a low potential conductive layer disposed at opposing surfaces of an intervening insulation layer;
a plurality of bus capacitors electrically connected to the laminated bus bar; and
the laminated bus bar and the bus capacitors having a combined inductance sufficiently low such that the bus capacitors are electrically connected effectively in parallel with the laminated bus bar.

2. The capacitor bank of claim 1, wherein:
the high potential conductive layer includes an array of high potential vias;
the low potential conductive layer includes an array of low potential vias;
the plurality of bus capacitors each have a respective high potential terminal which is connected at the high potential conductive layer of the laminated bus bar and a respective low potential terminal connected at the low potential conductive layer of the laminated bus bar; and
the bus capacitors are electrically connected effectively in parallel with the high potential vias and the low potential vias of the laminated bus bar.

3. A power supply apparatus comprising the capacitor bank of claim 2, and further comprising:
at least one power converter electrically connected to the bus bar across at least one of the high potential vias and at least one of the low potential vias, effectively in parallel with the bus capacitors, the power converter not housing a commutating capacitor.

4. The power supply apparatus of claim 3, wherein the at least one power converter is a first power converter of a plurality of power converters, all electrically connected effectively in parallel with the bus capacitors and having no internal commutating capacitors.

5. The power supply apparatus of claim 4, further comprising at least one DC current source electrically connected to the laminated bus bar effectively in parallel with the power converters.

6. The power supply apparatus of claim 5, wherein the at least one DC current source includes at least one of a battery, an ultra-capacitor, a photovoltaic cell, or a DC generator.

7. The power supply apparatus of claim 4, wherein the first power converter is configured as a master power converter, and the other power converters of the plurality of power converters are connected in data parallel to the master power converter.

8. The power supply apparatus of claim 4, wherein the first power converter is configured as a master power converter, and the other power converters of the plurality of power converters are connected in data series to the master power converter.

9. The power supply apparatus of claim 2, wherein the bus capacitors are connected at a first wing of the laminated bus bar, while the high potential vias and the low potential vias are formed at a second wing of the laminated bus bar that extends generally orthogonal to the first wing.

10. A power supply apparatus comprising the capacitor bank of claim 1, and further comprising:
at least one power converter electrically connected to the laminated bus bar so that it is effectively in parallel with the bus capacitors, the at least one power converter not including any commutating capacitors.

11. The power supply apparatus of claim 10, further comprising:
at least one DC current source electrically connected to the laminated bus bar effectively in parallel with the at least one power converter.

12. A power supply apparatus comprising:
a laminated bus bar having a high potential conductive layer and a low potential conductive layer disposed in close proximity at opposing surfaces of an intervening insulation layer, the high potential conductive layer including an array of high potential vias and the low potential conductive layer including an array of low potential vias;
plural bus capacitors each having a respective high potential terminal electrically connected to the high potential conductive layer and having a respective low potential terminal electrically connected to the low potential conductive layer of the bus bar; and
plural power converters connected across the high potential vias and the low potential vias, wherein the power converters have no commutating capacitors.

13. The power supply apparatus of claim 12, wherein each power converter houses only a respective ancillary capacitance.

14. The power supply apparatus of claim 12, wherein the power converters are spaced more closely together than a spacing between power converters of a power supply apparatus having commutating capacitors.

15. The power supply apparatus of claim 14, wherein
each power converter has net power density of at least about 2.6 W/cm3, and
the power converters are arrayed along the bus bar at no more than about 15 cm spacing on centers.

16. The power supply apparatus of claim 12, the power converters comprising at least one first power converter configured for supplying current to the laminated bus bar and at least one second power converter configured for receiving current from the laminated bus bar.

17. A laminated bus bar comprising:
an insulation layer extending along an axis and defining a profile orthogonal to the axis, the profile including a first wing and a second wing protruding at an angle from a longitudinal edge of the first wing;
a first conductive layer disposed at a first surface of the insulation layer;
a second conductive layer disposed at a second surface of the insulation layer opposite the first conductive layer;
first and second pluralities of vias formed, in electrical contact with the first conductive layer, through the first wing and through the second wing, respectively; and
third and fourth pluralities of vias formed, in electrical contact with the second conductive layer, through the first wing and through the second wing, respectively.

18. The laminated bus bar of claim 17, wherein the first and second conductive layers are in close proximity, such that the laminated bus bar presents minimal parasitic inductance across the pluralities of vias.

19. The laminated bus bar of claim 17, wherein the first and second pluralities of vias are arrayed along the axis of the laminated bus bar.

20. The laminated bus bar of claim 19, wherein the third and fourth pluralities of vias are arrayed along the axis at locations respectively corresponding to the first and second pluralities of vias.

21. The laminated bus bar of claim 17, wherein the profile is substantially uniform.

22. A power supply apparatus comprising:
the laminated bus bar of claim 17;
plural bus capacitors attached at the first wing and electrically connected across the first conductive layer and the second conductor layer by way of the first and third pluralities of vias; and
plural power converters attached at the second wing and electrically connected across the first conductive layer and the second conductor layer by way of the second and fourth pluralities of vias.
